(19) United States
(12) Patent Application Publication
(10) Pub. No.: US 2025/0012708 A1
(43) Pub. Date: Jan. 9, 2025

(54) APPARATUS AND METHODS FOR COMPUTATIONALLY INFORMED ADHESION MEASUREMENT USING THE BLISTER TEST

(71) Applicant: Board of Regents, The University of Texas System, Austin, TX (US)

(72) Inventors: Drishya DAHAL, San Antonio, TX (US); Juan-Sebastian RINCON-TABARES, San Antonio, TX (US); David Y. RISK-MORA, San Antonio, TX (US); Brendy C. RINCON TROCONIS, San Antonio, TX (US); David RESTREPO, San Antonio, TX (US)

(73) Assignee: Board of Regents, The University of Texas System, Austin, TX (US)

(21) Appl. No.: 18/763,115

(22) Filed: Jul. 3, 2024

Related U.S. Application Data
(60) Provisional application No. 63/511,805, filed on Jul. 3, 2023.

(51) Int. Cl. G01N 19/04

(52) U.S. Cl. CPC G01N 19/04

(57) ABSTRACT

The present disclosure is directed to characterizing the adhesion between thin films and rigid substrates. Exemplary embodiments provide systems, apparatus and methods to characterize mechanical mix-mode adhesion between thin films and rigid substrates using the blister test (BT). Exemplary embodiments provide the full triaxial displacement field obtained through Digital Image Correlation with inverse Finite Element Method simulations using Cohesive Zone Elements. Particular embodiments eliminate the need for making mechanistic or kinematic assumptions of the blister formation and allow the characterization of the full traction-separation law governing the adhesion between the film and the substrate. Exemplary embodiments can aid in the design and optimization of adhesively bonded structures by providing a comprehensive understanding of the adhesion mechanics between thin films and rigid substrates.

### CROSS-REFERENCE TO RELATED APPLICATION

This application claims priority to U.S. Provisional Patent Application No. 63/511,805, filed on Jul. 3, 2023, titled “Apparatus and Methods for Computationally Informed Adhesion Measurement Using the Blister Test”, which is incorporated by reference in its entirety for all purposes.

### STATEMENT REGARDING FEDERALLY SPONSORED RESEARCH AND DEVELOPMENT

This invention was made with government support under Grant No. 2000012920 awarded by the Gulf Research Program of the National Academies of Sciences, Engineering, and Medicine. The government has certain rights in the invention.

### BACKGROUND

### 1. Field of the Disclosure

The present disclosure relates generally to apparatus and methods for computationally informed adhesion measurement. More particularly, the present disclosure relates to apparatus and methods for computationally informed adhesion measurement using the blister test.

### 2. Background

The adhesion of thin films plays a pivotal role in various engineering industries, from improving corrosion protection through coatings[1], to the bonding of dissimilar materials in the automotive and aerospace sectors[2]. The adhesion of these films to rigid substrates is a key determinant of their effectiveness. Consequently, the study of adhesion mechanics is a critical area of research with significant implications for both scientific understanding and practical applications.

Several standard methods have been developed to characterize the adhesion of thin films. However, these methods often suffer from issues related to reproducibility, inability to quantify adhesion parameters, or overestimation of the adhesion strength and fracture energy[3]. Among the commonly used standards, the ASTM D3359[4], also known as the ‘tape test’ or ‘cross-hatch test’, involves creating parallel and perpendicular incisions on the coating and the use of pressure sensitive tape to rapidly remove the coating layer. Then, the percentage of undamaged coating is calculated, and the adhesion is classified on a zero to six scale. While this test is straightforward to execute, the interpretation of results may vary between evaluators. For instance, previous research has shown that this test produces a variability of 37% within laboratories and 70% between laboratories[5].

Another common adhesion test method is the ‘shear lap test’ described in ASTM D1002[6]. This test involves bonding two metal specimens with an adhesive and then subjecting the specimen to shear force until the adhesive fails. The force at failure is recorded and used to calculate the shear strength of the adhesive joint. However, ASTM D1002 only measures the shear strength of the adhesive joint, and it has been shown to produce nonuniform stress distribution in the joint depending on the material stiffness[7]. Similar limitations are observed for ASTM D4541[8], which determines the pull-off strength of coatings. In this test, a dolly is adhered to the coating, which is pulled off at a specific rate. The failure in this test is commonly characterized by a mixture of cohesive (failure due to rupture of coating) and adhesive (peeling off the coating layer) failures[9]. However, this test cannot accurately quantify adhesion measurements at the substrate/coating interface if cohesive failure occurs instead of adhesive failure or if a mixture of cohesive/adhesive failure occurs.

Another common adhesion technique, known as the “T-peel test”, is described in ASTM D1876[10]. This test method measures the force required to peel the adhering layer from a standard test panel at a specified angle and speed. One of the main limitations of this test is that it only measures the maximum force required to initiate separation between two bonded materials, but it does not provide any information about the mode of failure or the strength of the bond after separation. In addition, the high peel angle required to start the delamination may produce plastic deformation of the coating which increases the peel force, and therefore, overestimates the adhesion strength[11,12].

Recent studies have identified the blister test (BT) as a superior method for characterizing the adhesion of thin films[3,12-19]. The BT involves pressurizing the interface between the thin film and a substrate, creating a deformation (e.g. a blister or bubble) in the film. The adhesive interface is then allowed to debond by increasing the pressure in the blister, which enables the quantification of the energy required to initiate and propagate the blister, as well as the size and shape of the blister[13]. The BT can be performed in a variety of environments, including aqueous solutions and elevated temperatures, making it suitable for testing real-world conditions. Additionally, the test provides a quantifiable measurement of the fracture energy, and it is known to be highly reproducible [3,15,17,20-22]. Other variations of the BT use a rigid shaft to create a concentrated force to form the blister[23]. This approach has been demonstrated to be effective but is restricted to dry conditions, limiting its ability to experimentally simulate real-world conditions.

There are two main approaches to determine the fracture energy in the BT. The first approach, introduced in 1969 by Williams et al.[24], assumes that the blister formed in the coating layer is a perfect semi-sphere and that the bending stiffness of the thin film dominates the deformation during the test. The second approach, introduced by Gent & Lewandowski[11] in 1987, assumes that the dominant behavior during the deformation occurs due to membrane behavior, neglecting the effects of the bending stiffness of the thin film. Several extensions of these approaches have been suggested, such as the assumption of a perfect spherical blister under membrane behavior proposed by Briscoe and Panesar[25], and a delamination model proposed by Hutchinson[20] and Jensen[21] which approximates the debonding of the adhesive interface between the thin film and the substrate as the instability due to buckling in an Euler column.

However, each approach has its limitations. For instance, the work by Gent and Lewandowski assumes the product between the applied pressure to form the blister, and the radius of the inflated blister remains constant during the delamination, which only holds for a limited set of thin layer and substrate combinations such as polypropylene adhered to plexiglass or polyvinyl butyral adhered to AA2024 with specific surface finishes[11,15]. Additionally, assuming a spherical blister may not lead to accurate characterizations since it is known that blisters may grow in asymmetric or elongated configurations depending on the substrate surface conditions[15]. Finally, it is important to note that the formulations that consider the bending stiffness of the coating are not valid for adhering layers that do not resist bending (i.e. membranes) and will likely overestimate adhesion[25].

Accordingly, a need exists to accurately and consistently quantify the adhesion characteristics of the adhesive interface between thin films and rigid substrates.

### SUMMARY

Thus, in accordance with the present disclosure, systems, apparatus and methods are provided to characterize the full mechanical mix-mode adhesion characteristics of the adhesive interface between thin films and rigid substrates. Exemplary embodiments of the present disclosure combine Digital Image Correlation (DIC) and inverse Finite Element Method (FEM) simulations using Cohesive Zone Modeling (CZM). The cohesive response of the adhesive interface is obtained from inverse FEM simulations, utilizing the full triaxial displacement evolution of the blister formation correlated with the history of the applied pressure.

One major advantage of exemplary embodiments disclosed herein is that such embodiments eliminate the need to assume the shape of the blister or make any other mechanistic assumptions (e.g., bending stiffness vs. membrane). Also, exemplary embodiments of the present disclosure allow for the characterization of the full traction-separation law that governs the cohesive interface. Overall, this approach offers a more accurate and comprehensive understanding of the mechanical behavior of the adhesive interface. Exemplary embodiments disclosed herein build on previous works that used DIC coupled with inverse finite element simulations to determine the mechanical properties of different materials [26-29]. In the case of the BT, this technique has been applied to determine only the fracture energy under assumptions of normal loading (e.g., only mode I delamination)[30-32]. Exemplary embodiments analysis of the present disclosure provide a pressurized BT using CZM and 3-Dimensional DIC displacement information to characterize the full traction-separation law of the adhesive interface considering mixed-mode conditions.

Exemplary embodiments of the present disclosure include an apparatus comprising: a fixture comprising first opening and a channel; a substrate comprising a second opening; a coating bonded to the substrate, wherein the second opening is covered by the coating; a pump in fluid communication with the channel, the first opening, and the second opening; a fluid in the channel; a pressure transducer configured to measure a pressure of the fluid; an imaging system configured to capture imaging data of the coating; and a data analysis system. In specific embodiments, operation of the pump exerts a force against the coating via an increase in a pressure of the fluid and causes a deformation of the coating over the second opening in the substrate; the imaging system is configured to capture imaging data of the deformation of the coating; and the pressure transducer is configured to measure pressure data of the fluid.

In some embodiments, the data analysis system comprises: a computer processor; and a computer readable medium, where the computer readable medium comprises instructions that when performed by the computer processor perform steps to analyze interfacial debonding of the coating from the substrate. In particular embodiments the computer readable medium comprises instructions that when performed by the computer processor utilize full triaxial displacement evolution of the deformation of the coating correlated with a history of the pressure of the fluid. In certain embodiments the computer readable medium comprises instructions that when performed by the computer processor combines Digital Image Correlation (DIC) and inverse Finite Element Method (FEM) simulations using Cohesive Zone Modeling (CZM). In specific embodiments the CZM uses zero-thickness elements, and in some embodiments the CZM follows a Park-Paulino-Roesler (PPR) formulation. In particular embodiments the CZM utilizes a plurality of parameters of the deformation including four fracture parameters in a normal and a tangential direction. In some embodiments the plurality of parameters comprise adhesion fracture energies, cohesive strength, shape parameters, and initial slope indicators. In certain embodiments the initial slope indicators are defined by a ratio of an instantaneous crack opening displacement and a final crack displacement. In specific embodiments the cohesive strength corresponds to maximum tractions in a normal direction and a shear direction.

Exemplary embodiments of the present disclosure include a method of measuring interfacial debonding of an adhesive interface, where the method comprises forming a deformation of a coating, where: the coating is bonded to a substrate comprising an opening; the coating covers the opening; and the deformation is formed by increasing a pressure of a fluid in contact with the coating; where the method also comprises: acquiring imaging data of the deformation while forming the deformation; acquiring pressure data of the fluid while forming the deformation of the coating; and performing an analysis of an interfacial debonding of the coating from the substrate, where the analysis utilizes the imaging data and the pressure data.

In certain embodiments the analysis of the interfacial debonding of the coating from the substrate utilizes full triaxial displacement evolution of the deformation of the coating correlated with a history of the pressure of the fluid. In particular embodiments the analysis of the interfacial debonding of the coating from the substrate utilizes Digital Image Correlation (DIC) and inverse Finite Element Method (FEM) simulations using Cohesive Zone Modeling (CZM). In some embodiments the CZM uses zero-thickness elements. In specific embodiments the CZM follows a Park-Paulino-Roesler (PPR) formulation. In certain embodiments the CZM utilizes a plurality of parameters of the deformation including four fracture parameters in a normal and a tangential direction. In particular embodiments the plurality of parameters comprise adhesion fracture energies, cohesive strength, shape parameters, and initial slope indicators. In some embodiments the initial slope indicators are defined by a ratio of an instantaneous crack opening displacement and a final crack displacement. In specific embodiments the cohesive strength corresponds to maximum tractions in a normal direction and a shear direction. In certain embodiments the substrate and the coating are coupled to a fixture comprising first opening and a channel; the opening in the substrate is a second opening; the second opening is covered by the coating; the fluid in contact with the coating extends from the coating, through the channel, and to a pump; and increasing the pressure of the fluid in contact with the coating is performed by activating the pump.

In the following disclosure, the term “coupled” is defined as connected, although not necessarily directly, and not necessarily mechanically.

The use of the word “a” or “an” when used in conjunction with the term “comprising” in the claims and/or the specification may mean “one,” but it is also consistent with the meaning of “one or more” or “at least one.” The terms “about” and “approximately” mean, in general, the stated value plus or minus 5%. The use of the term “or” in the claims is used to mean “and/or” unless explicitly indicated to refer to alternatives only or the alternative are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed.

The terms “coating” or “film” and related terms refer to any layer of material that is relatively thinner than the substrate or surface to which the coating or film is applied or coupled.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will be apparent to those skilled in the art from this detailed description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The following drawings form part of the present specification and are included to further demonstrate certain aspects of the present invention. The invention may be better understood by reference to one or more of these drawings in combination with the detailed description of specific embodiments presented herein.

FIG. 1 displays a sectional schematic view of an apparatus according to an exemplary embodiment of the present disclosure.

FIG. 2 displays a finite element modeling (FEM) model associated with the embodiment of FIG. 1.

FIG. 3 displays graphical information illustrating an inverse determination of adhesive mechanical parameters associated with the embodiment of FIG. 1.

FIG. 4 displays graphical information illustrating the loading-unloading relationship for the normal traction associated with the embodiment of FIG. 1.

FIG. 5 illustrates a photograph of an apparatus equivalent to the embodiment of FIG. 1, as well as data obtained from the apparatus, including undeformed blister configuration imaging data, deformed blister configuration imaging data, and FEM mesh interpolated from Digital Image Correlation (DIC) region of interest (ROI).

FIG. 6 displays graphical information illustrating blister test (BT) results at an infusion rate of 10 mL/h showing pressure versus max Z displacement, and pressure vs change in radius obtained with the embodiment of FIG. 1.

FIG. 7 displays graphical information illustrating pressure versus Z displacement curves with computational results overlaid on experimental results obtained with the embodiment of FIG. 1.

FIG. 8 displays graphical information illustrating the error evolution during inverse FEM obtained with the embodiment of FIG. 1.

FIG. 9 displays graphical information illustrating the cohesive traction separation relationship for results obtained from FEM simulation for the average cohesive values within 1 standard deviation showing isometric view of the normal traction separation response and isometric view of the tangential traction separation response obtained with the embodiment of FIG. 1.

FIG. 10 displays graphical information illustrating Stress (a) vs Strain (E) data obtained with the embodiment of FIG. 1 relating to testing of a vinyl film.

### DESCRIPTION OF ILLUSTRATIVE EMBODIMENTS

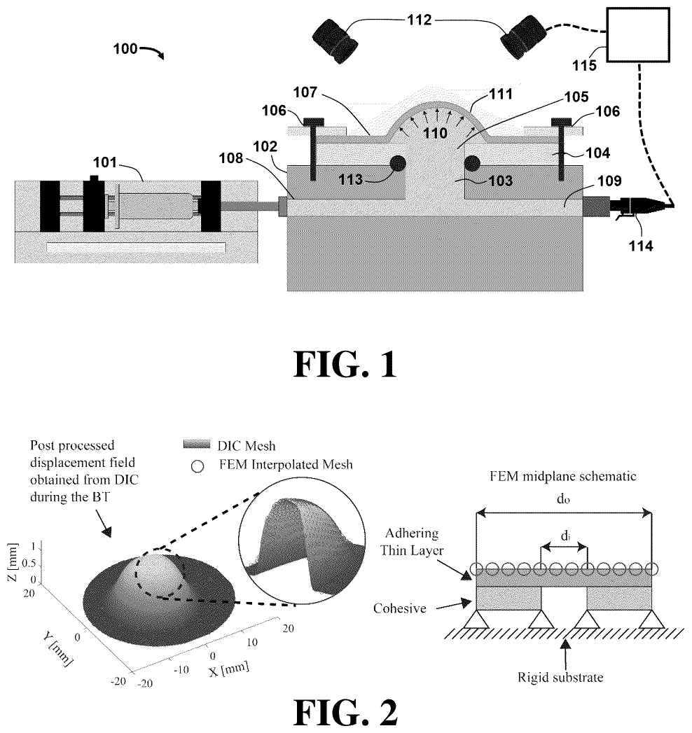

Referring initially to FIG. 1, an apparatus 100 is shown configured to perform the blister test (BT) and provide data acquisition according to exemplary embodiments of the present disclosure. In the illustrated embodiment, apparatus 100 comprises a pump 101 (e.g. a syringe pump in certain embodiments) in fluid communication with a fixture 102 comprising a first opening 103. A substrate 104 comprising a second opening 105 covered by a coating 107 is coupled to fixture 102 via retaining members 106. First opening 103 and second opening 105 can be sealed via a seal 113.

In the embodiment shown, a channel 108 in fixture 102 provides fluid communication between pump 101, first opening 103 and second opening 105. During operation of apparatus 100, pump 101 can be operated to increase the pressure of a fluid 109 (e.g. deionized water) in channel 108. Fluid 109 can therefore exert a force 110 against coating 107, which creates a deformation 111 (e.g. a blister) in coating 107 in the area over second opening 105.

Imaging data related to the formation of deformation 111 can be captured by imaging system 112. A pressure transducer 114 can also be used to measure the pressure of fluid 109 as deformation 111 is formed in coating 107. Imaging data from imaging system 112 and pressure data from pressure transducer 114 can be transmitted (e.g. via wired or wireless communication) to a data analysis system 115. In particular embodiments data analysis system 115 comprises a computer processor and a computer readable medium configured to analyze the imaging data and the pressure data. In particular, the computer readable medium comprises instructions that when performed by the computer processor perform steps according to a method of measuring interfacial debonding of an adhesive as disclosed herein.

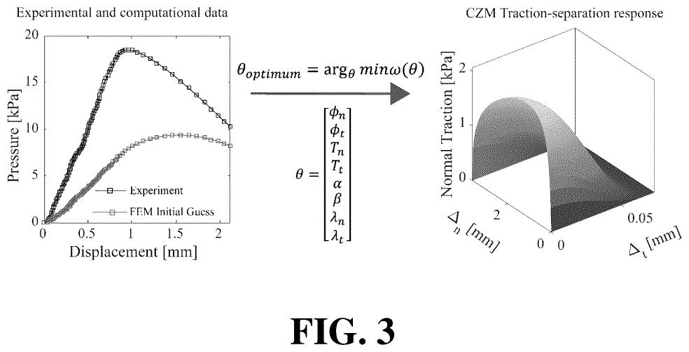

To fully characterize the mechanical mix-mode adhesion characteristics of the adhesive interface between thin films and rigid substrates, exemplary embodiments utilize Digital Image Correlation (DIC) and inverse finite element modeling (FEM) simulations in conjunction with the blister test. The computationally informed BT approach involves three main steps, as illustrated initially in FIGS. 1-3 and described below. In general, the first step comprises performing the BT and data acquisition (e.g. via apparatus 100 shown in FIG. 1). The second step comprises an FEM model set-up as shown in FIG. 2. The third step comprises inverse determination of adhesive mechanical parameters as shown in FIG. 3.

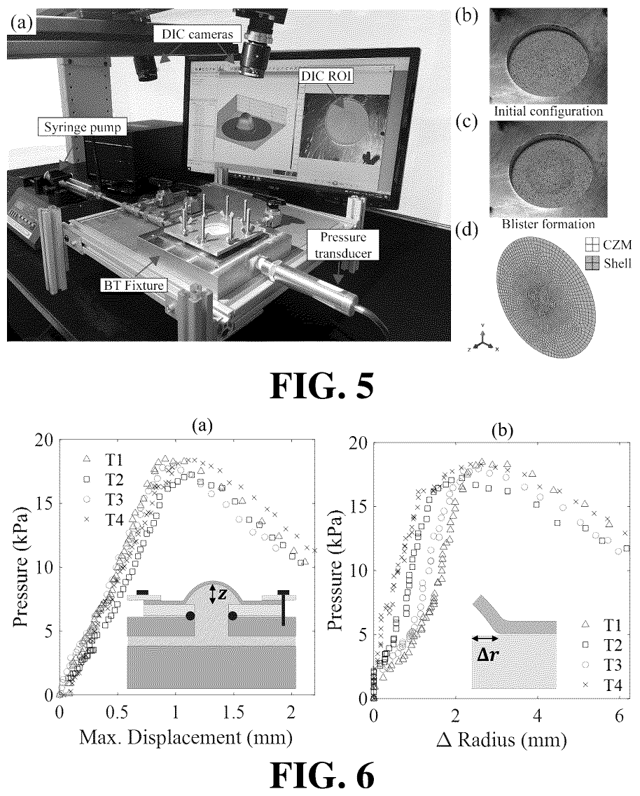

More specifically, the first step in the process corresponds to running the BT and performing the data acquisition of the blister pressure and its evolution during the test, along with the full 3-Dimensional displacement history of the blister formation using a DIC system. In one specific embodiment shown in FIG. 5, the testing equipment used included a high pressure SS316 syringe (50 mL New Era), a syringe pump (New Era NE 1010 E), a pressure transducer (Omega Engineering PX409-3.5KGUSBH), a SS316 test BT fixture body, SS316 tubing, and the VIC-3D DIC system (Correlated Solutions). Also, deionized (DI) water was used as the pressurizing fluid.

Step two in the process involves the data postprocessing to perform the inverse FEM characterization of the adhesive properties. In one exemplary embodiment discussed herein, the commercial FEM software Abaqus was used for the simulations. The adhesive interface was modeled using zero-thickness CZM elements following the Park-Paulino-Roesler (PPR)[33] formulation. This formulation can characterize the full mix-mode behavior of the adhesive interface response through four fracture parameters in each the normal and tangential direction denoted with the subscripts n and t, respectively. Specifically, these parameters include adhesion fracture energies (ϕₙ, ϕₜ), cohesive strength (Tₙ,Tₜ), shape parameters (α,β), and initial slope indicators (λₙ,λₜ) which are defined by the ratio of the instantaneous crack opening displacement (Δₙ,Δₜ) and the final crack opening displacement (δₙ,δₜ). Tn and Tₜ correspond to the maximum tractions in the normal (σₘₐₓ) and shear (τₘₐₓ) directions respectively. Additionally, δc represents the critical opening displacement after which delamination begins. When the crack opening displacement in either direction reaches the final normal or tangential separation, complete cohesive separation occurs. Finally, the adhesion or fracture energy parameters in the normal and tangential directions (ϕₙ, ϕₜ) are determined from the area under the traction separation curve.

The cohesive traction-separation curve in the PPR formulation can be obtained from a fracture potential given by:

$$Ψ ( {Δ}_{n} , {Δ}_{t} ) = min ( {ϕ}_{n} , {ϕ}_{t} ) + [ {{Γ}_{n} ( 1 - \frac{{Δ}_{n}}{{δ}_{n}} )}^{α} {( \frac{m}{α} + \frac{{Δ}_{n}}{{δ}_{n}} )}^{m} + 〈 {ϕ}_{n} - {ϕ}_{t} 〉 ] \times [ {{Γ}_{t} ( 1 - \frac{\vert {Δ}_{t} \vert}{{δ}_{t}} )}^{β} {( \frac{n}{β} + \vert {Δ}_{t} \vert {δ}_{t} )}^{n} + 〈 {ϕ}_{t} - {ϕ}_{n} 〉 ] \qquad ( 1 )$$

where, Γ are energy constants, m and n are non-dimensional exponents, and [symbol] · [symbol] is the Macaulay bracket, i.e.,

$$〈 x 〉 = \{ \begin{matrix}0 , & x < 0 \\ x , & x > 0\end{matrix} \qquad ( 2 )$$

The relationship between Γₙ and Γₜ and ϕₙ and ϕₜ is

$${Γ}_{n} = - {{ϕ}_{n}^{\frac{〈 {ϕ}_{n} - {ϕ}_{t} 〉}{{ϕ}_{n} - {ϕ}_{t}}} ( \frac{α}{m} )}^{m} \qquad ( 3 )$$

$${Γ}_{t} = - {{ϕ}_{t}^{\frac{〈 {ϕ}_{t} - {ϕ}_{n} 〉}{{ϕ}_{t} - {ϕ}_{n}}} ( \frac{β}{n} )}^{n} \qquad ( 4 )$$

and the exponents m and n are associated with the initial slopes of the traction separation-law governing the adhesive behavior as

$$m = \frac{α ( α - 1 ) {λ}_{n}^{2}}{( 1 - α {λ}_{n}^{2} )} \qquad ( 5 )$$

$$n = \frac{β ( β - 1 ) {λ}_{t}^{2}}{( 1 - β {λ}_{t}^{2} )} \qquad ( 6 )$$

Finally, δₙ and δₜ are obtained using

$${δ}_{n} = \frac{{ϕ}_{n}}{{σ}_{max}} α {{λ}_{n} ( 1 - {λ}_{n} )}^{α - 1} ( \frac{α}{m} + 1 ) {( \frac{α}{m} {λ}_{n} + 1 )}^{m - 1} \qquad ( 7 )$$

$${δ}_{t} = \frac{{ϕ}_{t}}{{τ}_{max}} β {{λ}_{t} ( 1 - {λ}_{t} )}^{β - 1} ( \frac{β}{n} + 1 ) {( \frac{β}{n} {λ}_{t} + 1 )}^{n - 1} \qquad ( 8 )$$

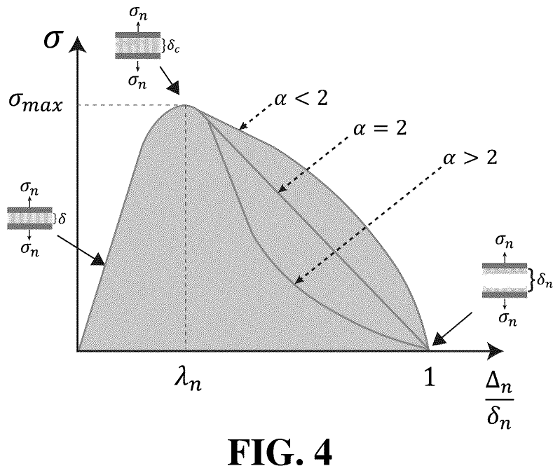

A representative traction separation curve for the normal direction is shown in FIG. 4. A similar response can also be characterized for the tangential direction.

FIG. 4 illustrates a depiction of the loading-unloading relationship for the normal traction. When a convex unloading relationship is obtained (α>2) and when a non-convex unloading relationship is obtained (α<2). A similar curve may be obtained in the tangential direction. Adapted from [27,33].

A user-defined element (UEL) subroutine in Abaqus was used to implement the PPR model. The computational implementation procedure is described in detail by Park et al.[33]. To account for the effect of the rigid substrate, the cohesive elements were fixed to restrain the displacements as shown in FIG. 2. The thin film adhering layer was modeled using shell elements, and the thickness of the layer was obtained from the material data sheet[34]. This value was validated using a coating thickness probe (PosiTector® 6000). A linear elastic material behavior for the adhering layer was assumed; however, it should be noted that the method presented here is general and can be used in conjunction with other nonlinear material behaviors of the adhering layer, such as hyperelastic or elastic-plastic behavior. Before the simulations, the 3-Dimensional displacement history of the blister formation obtained with the DIC system is interpolated into the finite element mesh of the adhering layer and used as the displacement control input (see FIG. 2). To achieve this feature, the DIC displacement fields were exported in triangular mesh format and using the MATLAB function griddata[35], the DIC mesh was converted to match the FEM mesh.

In this embodiment, the third step involves determining the traction-separation law of the adhesion between the adhering layer and the substrate using inverse FEM. This process involves solving a mathematical optimization problem to identify the cohesive material properties that best described the delamination behavior characterized in Step 1 (see FIG. 3).

To inversely determine the cohesive material parameters, the optimization problem θₒₚₜᵢₘᵤₘ=arg_{θ} min ω(θ) was solved, where θ is a vector consisting of the CZM material parameters to be optimized as

$$θ = [ {ϕ}_{n} , {ϕ}_{t} , {T}_{n} , {T}_{t} , α , β , {λ}_{n} , {λ}_{t} ] \qquad ( 9 )$$

and ω(θ) is the residual function, which compares the experimental and computational pressure-displacement curves and DIC data, is defined as

$$ω ( θ ) = {‖ {R}_{p} ‖}^{2} \qquad ( 10 )$$

where

$${R}_{p} = {Σ}_{t} \frac{{P}_{t}^{E X P} - {P}_{t}^{COMP} ( θ )}{‖ {P}^{E X P} ‖} \qquad ( 11 )$$

and the superscripts “EXP” and “COMP” refer to the experimental and computationally retrieved pressures (P), respectively. Rₚ is computed for every loading increment of the finite element simulation. The computational pressure, P^{COMP} is obtained as

$${P}^{C O M P} ( θ ) = \frac{R F}{Area} \qquad ( 12 )$$

where RF is the magnitude of the reaction forces on the base of the cohesive elements and Area refers to the area covered by the CZM parameters.

To perform the optimization, a direct search method was implemented using an updated Nelder-Mead simplex algorithm, as described by Lagarias et al.[36]. MATLAB's optimization toolbox (fminsearch) was used for this purpose. The solution to the optimization process provides the CZM parameters that accurately describe the delamination behavior of the adhering layer and the substrate.

In the specific embodiment discussed herein, the adhesive properties of a vinyl-wrap (3M™ Controltac™ 2080) on a cleaned aluminum AA6061 substrate were characterized. To this end, four aluminum AA6061 specimens with dimensions of 50.8 mm×50.8 mm were cut from a 4.06 mm thick sheet. A 12.7 mm diameter hole (dᵢ) was created on each substrate using an end mill. Then, the substrates were cleaned in three 500 mL baths, consisting of degreasing, alkaline and acidic etching solutions as outlined in Table 1. Following the alkaline etching and acidic etching baths, complete wettability of the substrate was visually ensured. After cleaning and drying, the substrates were wrapped in aluminum foil sheets and used for blister testing within 30 hours to prevent contamination and/or surface degradation.

TABLE 1
Pretreatment Parameters Including Sequence,
Bath Chemistry, Time, and Temperature

| | | Bath | | |
|---|---|---|---|---|
| Steps | Bath | Chemistry | Time | Temperature |
| 1 | Degreasing | 0.5 mL Dawn | 20 s immersion | 58° C. |
| 2 | Tap Water | dish soap in 500 | 10 s immersion + | Ambient |
| | | mL of tap water | 5 s spray | Temperature |
| 3 | Alkaline | 0.25 mL Dawn | 20 s immersion | 58° C. |
| | Etching | dish soap + 3 mL | | |
| 4 | Tap Water | of 45% w/w KOH | 10 s immersion | Ambient |
| | | in 500 mL tap | | Temperature |
| 5 | DI water | water | 10 s immersion | Ambient |
| | | | | Temperature |
| 6 | Acidic | 0.05 mL of | 20 s immersion | 58° C. |
| | Etching | Dawn soap + 6 | | |
| 7 | DI water | mL 98% H₂SO₄ | 10 s immersion + | Ambient |
| | | in 500 mL DI | 5 s spray | Temperature |
| 8 | Air Dry | water | 16 h | Ambient |
| | | | | Temperature |

In the specific embodiment discussed herein, to prepare the thin film adhesive layer, 2 in×2 in squares of a 0.35 mil (0.089 mm) thick white vinyl-wrap from 3M™ were cut just before testing. The vinyl-wrap has an acrylic-based adhesive on one side of the film. To fix the film, light finger pressure was applied, followed by firmly pressing the film onto the substrate using a plastic card, in accordance with the manufacturer's instructions [37]. After assembly of the thin film adhesive layer and substrate pairs, the samples were prepared for DIC. Speckle patterns were made on the film surface using a commercially available spray paint (e.g. Rust-Oleum®). Once the speckle pattern dried, the specimen was clamped using a plate with central hole with an inner diameter (dₒ) of 40.64 mm. The patterns were tracked by the DIC system on the inner diameter of the clamping plate to obtain full field deformation information of the blister. A schematic of the test setup is shown in FIG. 5 panel (a). FIG. 5 panel (b) illustrates undeformed blister configuration. FIG. 5 panel (c) illustrates deformed blister configuration, and FIG. 5 panel (d) illustrates FEM mesh interpolated from DIC region of interest (ROI).

Before performing the BT, a maneuver protocol was followed to minimize trapped air bubbles in the system, which may affect the pressure rate during loading. In prior work, some authors have highlighted this step in their BT configurations[15,16]. The DIC system was calibrated prior to each test to record the full field displacement over the entire test duration. This calibration consisted in adjusting the field of view for maximum focus and brightness. Under these conditions, the BTs were performed with a constant DI water infusion rate of 10 mL/h. Both the DIC and pressure transducer systems were set to operate at a data acquisition rate of 10 s⁻¹. Representative images of the thin film and substrate system before and after blister formation are shown in FIG. 5 panel (b) and FIG. 5 panel (c), respectively.

For the simulations, a circular shaped FEM model was created consisting 2356 four-node shell elements (S4) and 1689 eight-node CZM elements, with the shell elements stacked on top of the CZM (see FIG. 5 panel (d)). The shell element thickness was set to 0.089 mm, and the material behavior was considered linear elastic (E=0.23 GPa and v=0.46)

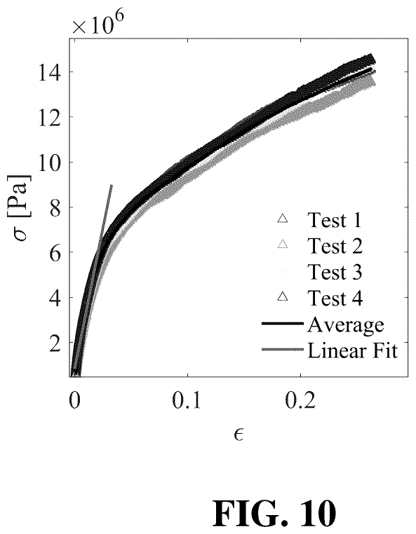

For material uniaxial tensile test data, the procedure described in ASTM D882-Standard Test Method for Tensile Properties of Thin Plastic Sheeting [45] was used to characterize the stress-strain response of the 3M™ Controltac™ 2080 using an Instron uniaxial tensile test machine FIG. 10 displays graphical information illustrating Stress (σ) vs Strain (ϵ) of 3M™ Controltac™ 2080 film). The obtained Young's Modulus value agreed with previous work [19]. The displacements obtained from the tensile test equipment were verified using DIC.

The CZM elements were located on an annular circle with an inner hole diameter dᵢ and outer diameter equal to dₒ as defined in FIG. 2. The base nodes of the CZM elements were fixed to include the effects of the clamp on the rigid substrate. Using the procedure described previously in the discussion of FIGS. 1-4, the BT was performed and the CZM properties were determined using an inverse analysis.

### Results and Discussion

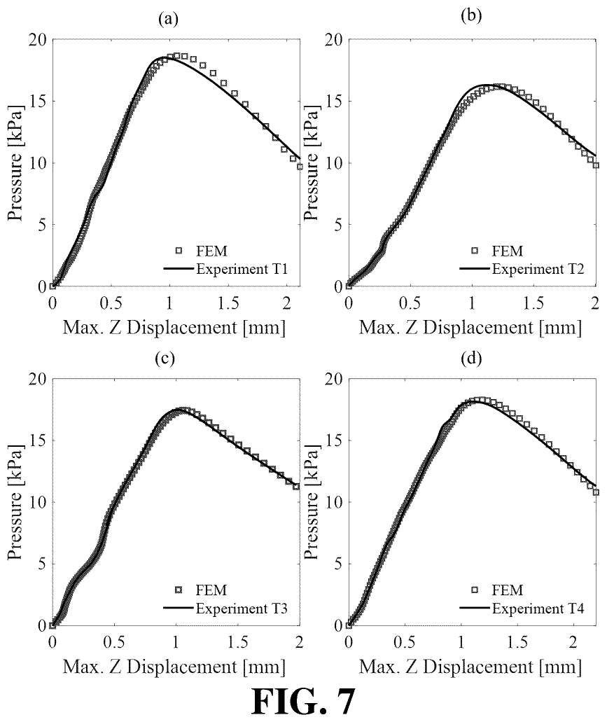

The experimental results for the four tests of cleaned samples (T1-T4) are presented in FIG. 6, which illustrates BT results at an infusion rate of 10 mL/h showing (a) pressure vs max Z displacement and (b) pressure vs change in radius.

As observed in FIG. 6 panel (a), excellent reproducibility of test replicates is obtained when the pressure is plotted against the maximum displacement in blister height. The average coefficient of variation (COV) across the four sets of experimental pressures equaled to 11.1%. This is consistent with previous reports for the BT[38]. It can be seen that the pressure increases until it reaches a maximum critical value (P_{c}) after which there is a significant decrease. The average P_{c} measured for the four test replicates were found to be 18.04±0.63 kPa at which the average blister height (z_{c}) was 1.1±0.15 mm. In FIG. panel (b), the blister pressure is plotted against the change in blister radius (Δr) by assuming a circular fit on the blistered configuration using a fitting method described by Pratt[39]. Under this assumption, it can be observed that initially Δr is zero as the pressure increases, but an increase in Δr follows at a pressure of 2.15±0.21 kPa, signifying the onset of delamination (adhesive failure). There have been studies where the delamination onset was reported at P_{c} [11], but the current observation was consistent with recent work which suggested that the delamination occurred before P_{c} [15,18,19]. The radius continued growing in a nonlinear rate after the onset, achieving Δr equal to 2.61±0.03 mm at P_{c}. However, it must be noted that fitting a perfect circle to obtain Δr, may lead to unintended noise, and could be a possible cause of the variability during loading obtained in FIG. 6 panel (b), which highlights the importance of measuring the full displacement field of the blister evolution during the BT.

FIG. 7 illustrates Pressure versus Z displacement curves from (a)-(d), showing computational results overlaid on experimental results from T1-T4. The inverse FEM results for four replicate BT are presented in FIG. 7, showing good agreement in pressure trends between the experimental and computational results (R²: 0.99). A COV of 11.3% was obtained across the four FEM results, similar to what was obtained from the experiments. The figures illustrate that the computational simulation was able to accurately predict the pressure response during the BT experiments. Overall, the results demonstrate the capability of the inverse FEM method to predict the blister behavior of the system under investigation.

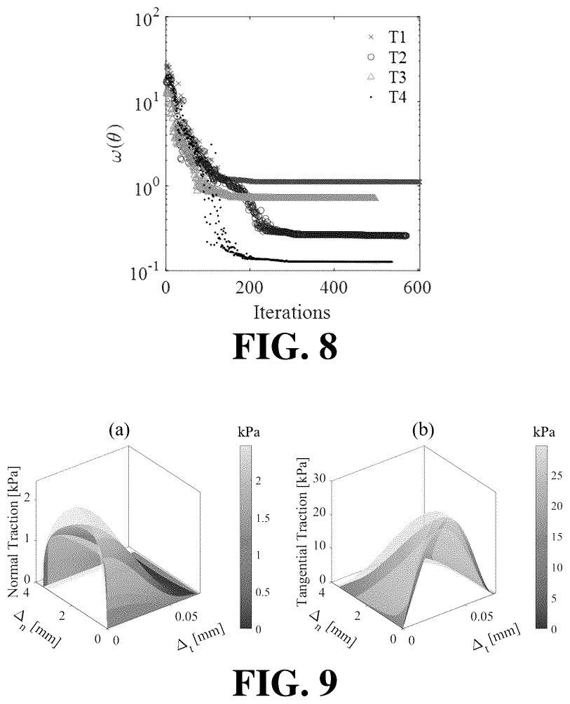

FIG. 8 illustrates the error evolution during inverse FEM. The error evolution during the inverse optimization process is depicted in FIG. 8 for four replicates of the BT. The errors decreased significantly with the number of iterations and converged between 200-300 iterations, with T4 obtaining the least error.

Using the pressure output from the inverse FEM, the corresponding cohesive element parameters were obtained (see Table 2). The results reveal that the normal energy is higher than the tangential energy

$$( 6.16 \pm 0.97 \frac{J}{{m}^{2}} vs 1.16 \pm 0.08 \frac{J}{{m}^{2}} ) .$$

This finding suggests that larger energy is required to achieve complete delamination of the coating from the substrate in the normal direction, while only a small amount of energy is needed for delamination in the tangential direction. On the other hand, a lower maximum traction of 2.06±0.62 kPa is seen in the normal direction compared to 27.41±2.33 kPa in the tangential direction.

TABLE 1
Cohesive element parameters obtained for experiment replicates T1-T4

| | ϕₙ | ϕₜ | | | | | | |
|---|---|---|---|---|---|---|---|---|
| FEM | $( \frac{J}{{m}^{2}} )$ | $( \frac{J}{{m}^{2}} )$ | Tₙ (kPa) | T (kPa) | α | β | λₙ | λₜ |
| T1 | 6.17 | 1.13 | 1.54 | 27.70 | 1.29 | 3.24 | 0.19 | 0.46 |
| T2 | 6.04 | 1.29 | 2.70 | 30.61 | 1.02 | 3.31 | 0.28 | 0.54 |
| T3 | 5.03 | 1.14 | 1.48 | 25.65 | 1.44 | 2.48 | 0.41 | 0.55 |
| T4 | 7.39 | 1.47 | 2.55 | 25.69 | 1.49 | 2.85 | 0.39 | 0.41 |
| Mean | 6.16 ± | 1.18 ± | 2.06 ± | 27.41 ± | 1.31 ± | 2.97 ± | 0.31 ± | 0.48 ± |
| | 0.97 | 0.08 | 0.63 | 2.33 | 0.21 | 0.38 | 0.10 | 0.07 |

FIG. 9 displays graphical information illustrating cohesive traction separation relationship for results obtained from FEM simulation for the average cohesive values within 1 standard deviation. FIG. 9 panel (a) shows isometric view of the normal traction separation response, while panel (b) illustrates an isometric view of the tangential traction separation response.

These results indicate the cohesive elements in the tangential directions were able to withstand higher shear stresses before failure, resulting in higher maximum tractions compared to the normal direction. FIG. 9 shows the complete traction-separation response of the cohesive element using the mean values of the cohesive parameters reported in Table 2. The pink shadow overlay indicates the variability in the traction-separation law. As presented in Table 2, the normal and tangential energies from the PPR model can be determined from the traction-separation surface. Although the traction-separation law for the normal and tangential cases are plotted separately, it is worth noting that the BT is a mixed loading condition. Therefore, the actual traction response lies within the presented traction surface, resulting in the response highlighted in FIG. 7.

The concept of normal and shear energy models in fracture mechanics is a topic of considerable discussion in the literature, with conflicting results reported by various authors [12,40]. For instance, Liu et. al[41] showed that the energy for the shear mode was higher than the normal mode for a structural epoxy tested using mix mode bending test. However, in reality, shear loading often leads to torturous fracture paths that can result in impingement, frictional dissipation, smearing of protruding features, and other phenomena, potentially causing shear energies to appear higher than they actually are[42]. The loading angle of the test has shown to play a significant role in the probability of having a large shear or normal energy, as demonstrated by Pirondi et al and Choupani [43,44]. Their studies suggest that loading angles greater than 60° results in higher shear energies compared to normal energies for bonded materials. In the current BT study, however, the loading angle between the substrate and adhering layer was low, i.e., between 12° and 15° for the tested specimens at P_{c}, as measured using the DIC data. This low loading angle could explain why the normal energy was observed to be higher than the shear energy in the computational analysis.

However, it should also be noted that the relative magnitudes of the normal and shear energies may depend on various factors, such as the test method, material properties, surface treatment, and loading conditions. To compare the adhesion between these factors, one needs to consider two variables from the traction separation law: fracture energy and maximum traction in the normal and tangential directions. Depending on the engineering application, higher tangential or normal components may be more desirable. Therefore, a careful consideration of these factors is required when interpreting the results of adhesion tests.

Exemplary embodiments of the present disclosure provide a methodology for analyzing interfacial debonding mechanics during the BT, using a combination of experimental and computational techniques. Exemplary embodiments can be a reliable and effective tool for comprehensively characterizing the mix-mode traction separation law governing the mechanical behavior of the adhesive interface. Unlike prior methods, exemplary embodiments of the present disclosure eliminate the need for making mechanistic or kinematic assumptions of the blister formation. Instead, exemplary embodiments analyze the complete delamination mechanics using the full triaxial displacement field obtained through DIC with inverse Finite Element Method simulations using Cohesive Zone Elements. This allows accounting of any irregularities in blister growth, enables decoupling of adhesion parameters in both the normal and tangential directions, and provides the full traction-separation law that governs the adhesive behavior.

In an embodiment disclosed herein, the DIC-informed inverse finite elements and BT framework was used to analyze the adhesion mechanics between a 3M™ Controltac™ 2080 vinyl film and a cleaned AA6061 substrate. The results demonstrated that the computational simulation was able to accurately predict the pressure behavior during the BT with a R² of 0.99. The results indicate that the vinyl film can absorb higher energies before complete failure in the normal direction (6.16±0.97 J/m²) compared to the tangential direction (1.18±0.08 J/m²) when bonded to a cleaned AA6061 substrate. Furthermore, the cohesive elements in the tangential directions (27.41±2.33 kPa) were able to withstand higher shear stresses before failure, resulting in higher maximum tractions compared to the normal direction (2.06±0.62 kPa). These results were obtained while the loading angle between the substrate and adhering layer was low, i.e., between 12° and 15° for the tested specimens at Pc, which ratifies the ability of this computational tool to provide a true representative behavior of the mix-mode traction separation law governing the mechanical behavior of the adhesive interface without the overestimation due to plastic deformation of the adhering layer.

The DIC-informed inverse finite elements and the blister test can be implemented to account for the nonlinear material response of the coating or the effects of substrate surface treatment on adhesion. This makes exemplary embodiments of the present disclosure a valuable tool for studying the adhesion mechanics of thin films in various engineering applications. Overall, exemplary embodiments as disclosed herein provide a comprehensive and reliable approach for characterizing the adhesion behavior of thin films to rigid substrates and has the potential for broad applications in the field of materials science and engineering, including the design and optimization of adhesively bonded structures and multicoating systems.

All of the devices and methods disclosed and claimed herein can be made and executed without undue experimentation in light of the present disclosure. While the devices and methods of this disclosure have been described in terms of preferred embodiments, it will be apparent to those of skill in the art that variations may be applied to the devices and methods and in the steps or in the sequence of steps of the method described herein without departing from the concept, spirit and scope of the disclosure. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the disclosure as defined by the appended claims.

### REFERENCES

The following references are incorporated herein by reference.
[1] S. D. Cramer, C. B. S. J., ASM Corrosion Handbook, Anti-Corrosion Methods and Materials, 2003. https://doi.org/10.1108/acmm.2003.12850daf.001.
[2] D. Baek, K. B. Sim, H. J. Kim, Mechanical Characterization of Core-Shell Rubber/Epoxy Polymers for Automotive Structural Adhesives as a Function of Operating Temperature, (2021). https://doi.org/10.3390/polym13050734.
[3] B. C. Rincon Troconis, G. S. Frankel, Effects of pretreatments on the adhesion of acetoacetate to AA2024-T3 using the blister test, Corrosion. 70 (2014) 483-495. https://doi.org/10.5006/1178.
[4] ASTM D01 Committee, Test Methods for Rating Adhesion by Tape Test, ASTM International, n.d. https://doi.org/10.1520/D3359-23.
[5] M. Rezaee, L. tsai, M. Istiaque Haider, A. Yazdi, ehsan Sanatizadeh, nathan Salowitz, Quantitative peel test for thin films/layers based on a coupled parametric and statistical study, (n.d.). https://doi.org/10.1038/s41598-019-55355-9.
[6] ASTM D14 Committee, Test Method for Apparent Shear Strength of Single-Lap-Joint Adhesively Bonded Metal Specimens by Tension Loading (Metal-to-Metal), ASTM International, n.d. https://doi.org/10.1520/D1002-10R19.
[7] M. Karny, On the Aerospace-Grade Adhesives Shear Strength Testing with ASTM D5656 Test as an Example, Transactions on Aerospace Research. 2019 (2019) 27-37. https://doi.org/10.2478/tar-2019-0008.
[8] ASTM D01 Committee, Standard Test Method for Pull-Off Strength of Coatings Using Portable Adhesion, ASTM International. (2014) 1-16. https://doi.org/10.1520/D4541-22.
[9] W. Funke, Problems and progress in organic coatings science and technology’, Progress in Organic Coatings. 31 (1996) 5-9.
[10] ASTM D14 Committee, Test Method for Peel Resistance of Adhesives (T-Peel Test), ASTM International, n.d. https://doi.org/10.1520/D1876-08R15E01.
[11] A. N. Gent, L. H. Lewandowski, BLOW-OFF PRESSURES FOR ADHERING LAYERS, Arkon, 1986.
[12] M. D. Bartlett, S. W. Case, A. J. Kinloch, D. A. Dillard, Peel tests for quantifying adhesion and toughness: A review, Progress in Materials Science. 137 (2023) 101086. https://doi.org/10.1016/j.pmatsci.2023.101086.
[13] Z. Yang, J. Sun, K. Li, Y. Lian, X. He, Z. Zheng, Theoretical Study on Synchronous Characterization of Surface and Interfacial Mechanical Properties of Thin-Film/Substrate Systems with Residual Stress Based on Pressure Blister Test Technique, Polymers. 10 (2018) 49. https://doi.org/10.3390/polym10010049.
[14] B. C. Rincon Troconis, Blister Test for Measurements of Adhesion and Adhesion Degradation of Organic Polymers on AA2024-T3, (2013).
[15] B. C. Rincon Troconis, G. S. Frankel, Effect of Roughness and Surface Topography on Adhesion of PVB to AA2024-T3 using the Blister Test, Surface and Coatings Technology. 236 (2013) 531-539. https://doi.org/10.1016/j.surfcoat.2013.10.046.
[16] Z. Cao, P. Wang, W. Gao, L. Tao, J. W. Suk, R. S. Ruoff, D. Akinwande, R. Huang, K. M. Liechti, A blister test for interfacial adhesion of large-scale transferred graphene, Carbon. 69 (2014) 390-400. https://doi.org/10.1016/j.carbon.2013.12.041.
[17] A. Sofla, E. Seker, J. P. Landers, M. R. Begley, PDMS-Glass interface adhesion energy determined via comprehensive solutions for thin film bulge/blister tests, Journal of Applied Mechanics, Transactions ASME. 77 (2010) 1-5. https://doi.org/10.1115/1.4000428.
[18] N. W. Khun, B. C. Rincon Troconis, G. S. Frankel, Effects of carbon nanotube content on adhesion strength and wear and corrosion resistance of epoxy composite coatings on AA2024-T3, Progress in Organic Coatings. 77 (2014) 72-80. https://doi.org/10.1016/j.porgcoat.2013.08.003.
[19] M. Kappes, G. S. Frankel, N. Sridhar, Adhesion and adhesion degradation of a pressure sensitive tape on carbon steel, Progress in Organic Coatings. 69 (2010) 57-62. https://doi.org/10.1016/j.porgcoat.2010.05.005.
[20] J. W. Hutchinson, Z. Suo, Mixed Mode Cracking in Layered Materials, Advances in Applied Mechanics. 29 (1991) 63-191. https://doi.org/10.1016/50065-2156(08)70164-9.
[21] H. M. Jensen, The blister test for interface toughness measurement, Engineering Fracture Mechanics. 40 (1991) 475-486. https://doi.org/10.1016/0013-7944(91)90144-P.
[22] J. A. Hinkley, A Blister Test for Adhesion of Polymer Films to SiO2, The Journal of Adhesion. 16 (1983) 115-125. https://doi.org/10.1080/00218468308074909.
[23] S. de Barros, B. M. Fadhil, F. Alila, J. Diop, J. M. L. Reis, P. Casari, F. Jacquemin, Using blister test to predict the failure pressure in bonded composite repaired pipes, Composite Structures. 211 (2019) 125-133. https://doi.org/10.1016/j.compstruct.2018.12.030.
[24] M. L. Williams, K. L. de Vries, R. R. Despain, A Technique for Evaluating Dental Adhesives, Journal of Dental Research. 52 (1973) 517-521. https://doi.org/10.1177/00220345730520032301.
[25] A. B. J. Briscoe, S. S. Panesar, The application of the blister test to an elastomeric adhesive, Proceedings of the Royal Society of London. Series A: Mathematical and Physical Sciences. 433 (1991) 23-43. https://doi.org/10.1098/rspa.1991.0033.
[26] G. Nsengiyumva, Y. R. Kim, Field Displacement-Based Inverse Method for Elastic and Viscoelastic Constitutive Properties, Exp Mech. 62 (2022) 1553-1568. https://doi.org/10.1007/s11340-022-00876-0.
[27] D. Ramirez-Tamayo, A. Soulami, V. Gupta, D. Restrepo, A. Montoya, H. Millwater, A complex-variable cohesive finite element subroutine to enable efficient determination of interfacial cohesive material parameters, Engineering Fracture Mechanics. 247 (2021) 107638. https://doi.org/10.1016/j.engfracmech.2021.107638.
[28] B. C. Hill, O. Giraldo-Londoño, G. H. Paulino, W. G. Buttlar, Inverse Estimation of Cohesive Fracture Properties of Asphalt Mixtures Using an Optimization Approach, Exp Mech. 57 (2017) 637-648. https://doi.org/10.1007/s11340-017-0257-3.
[29] E. Jungstedt, S. Östlund, L. A. Berglund, Transverse fracture toughness of transparent wood biocomposites by FEM updating with cohesive zone fracture modeling, Composites Science and Technology. 225 (2022) 109492. https://doi.org/10.1016/j.compscitech.2022.109492.
[30] S. de Barros, B. M. Fadhil, F. Alila, J. Diop, J. M. L. Reis, P. Casari, F. Jacquemin, Using blister test to predict the failure pressure in bonded composite repaired pipes, Composite Structures. 211 (2019) 125-133. https://doi.org/10.1016/j.compstruct.2018.12.030.
[31] W. G. Jiang, Y. Wu, Q. H. Qin, D. S. Li, X. B. Liu, M. F. Fu, A molecular dynamics based cohesive zone model for predicting interfacial properties between graphene coating and aluminum, Computational Materials Science. 151 (2018) 117-123. https://doi.org/10.1016/j.commatsci.2018.05.008.
[32] C. Liu, M. L. Lovato, K. D. Clarke, D. J. Alexander, W. R. Blumenthal, Miniature bulge test and energy release rate in HIPed aluminum/aluminum interfacial fracture, Journal of the Mechanics and Physics of Solids. 120 (2018) 179-198. https://doi.org/10.1016/j.jmps.2017.10.006.
[33] K. Park, G. H. Paulino, Computational implementation of the PPR potential-based cohesive model in ABAQUS: Educational perspective, Engineering Fracture Mechanics. 93 (2012) 239-262. https://doi.org/10.1016/j.engfracmech.2012.02.007.
[34] 3M™ Wrap Film Series 1080, (n.d.). https://www.3 m.com/3M/en_US/p/d/b00021027/(accessed Mar. 14, 2023).
[35] Interpolate 2-D or 3-D scattered data-MATLAB griddata, (n.d.). https://www.mathworks.com/help/matlab/ref/griddata.html.
[36] J. C. Lagarias, J. A. Reeds, M. H. Wright, P. E. Wright, Convergence Properties of the Nelder-Mead Simplex Method in Low Dimensions, SIAM J. Optim. 9 (1998) 112-147. https://doi.org/10.1137/S1052623496303470.
[37] General Procedures for Interior and Exterior Dry Application, (n.d.). https://multimedia.3 m.com/mws/media/10022300/instruction-bulletin-5-5-general-procedures-for-interior-and-exterior-dry-application.pdf (accessed Apr. 28, 2023).
[38] Development of a Pressurized Blister Test for Interface Characterization of Aggregate Highly Polymerized Bituminous Materials, (n.d.). https://ascelibrary.org/doi/epdf/10.1061/%28ASCE %29MT.1943-5533.0000222 (accessed Apr. 13, 2023).
[39] V. Pratt, Direct least-squares fitting of algebraic surfaces, Proceedings of the 14th Annual Conference on Computer Graphics and Interactive Techniques, SIGGRAPH 1987. (1987) 145-152. https://doi.org/10.1145/37401.37420.
[40] Suresh S: Fatigue of materials. 2nd ed. Cambridge University Press; 1998., (n.d.).
[41] Z. Liu, R. F. Gibson, G. M. Newaz, The Use of a Modified Mixed Mode Bending Test for Characterization of Mixed-mode Fracture Behavior of Adhesively Bonded Metal Joints, (n.d.). https://doi.org/10.1080/00218460210408.
[42] K. Leffler, K. S. Alfredsson, U. Stigh, Shear behaviour of adhesive layers, International Journal of Solids and Structures. 44 (2007) 530-545. https://doi.org/10.1016/j.ijsolstr.2006.04.036.
[43] A. Pirondi, G. Nicoletto, Mixed Mode I/II fracture toughness of bonded joints, International Journal of Adhesion and Adhesives. 22 (2002) 109-117. https://doi.org/10.1016/S0143-7496(01)00042-2.
[44] N. Choupani, Mixed-mode cohesive fracture of adhesive joints: Experimental and numerical studies, Engineering Fracture Mechanics. 75 (2008) 4363-4382. https://doi.org/10.1016/j.engfracmech.2008.04.023.
[45] ASTM D20 Committee, Test Method for Tensile Properties of Thin Plastic Sheeting, ASTM International, n.d. https://doi.org/10.1520/D0882-18.

What is claimed is:

1. An apparatus comprising:
a fixture comprising first opening and a channel;
a substrate comprising a second opening;
a coating bonded to the substrate, wherein the second opening is covered by the coating;
a pump in fluid communication with the channel, the first opening, and the second opening;
a fluid in the channel;
a pressure transducer configured to measure a pressure of the fluid;
an imaging system configured to capture imaging data of the coating; and
a data analysis system, wherein:
operation of the pump exerts a force against the coating via an increase in a pressure of the fluid and causes a deformation of the coating over the second opening in the substrate;
the imaging system is configured to capture imaging data of the deformation of the coating; and
the pressure transducer is configured to measure pressure data of the fluid.

2. The apparatus of claim 1 wherein the data analysis system comprises:
a computer processor; and
a computer readable medium, wherein:
the computer readable medium comprises instructions that when performed by the computer processor perform steps to analyze interfacial debonding of the coating from the substrate.

3. The apparatus of claim 2 wherein the computer readable medium comprises instructions that when performed by the computer processor utilize full triaxial displacement evolution of the deformation of the coating correlated with a history of the pressure of the fluid.

4. The apparatus of claim 2 wherein the computer readable medium comprises instructions that when performed by the computer processor combines Digital Image Correlation (DIC) and inverse Finite Element Method (FEM) simulations using Cohesive Zone Modeling (CZM).

5. The apparatus of claim 4 wherein the CZM uses zero-thickness elements.

6. The apparatus of claim 4 wherein the CZM follows a Park-Paulino-Roesler (PPR) formulation.

7. The apparatus of claim 4 wherein the CZM utilizes a plurality of parameters of the deformation including four fracture parameters in a normal and a tangential direction.

8. The apparatus of claim 7 wherein the plurality of parameters comprise adhesion fracture energies, cohesive strength, shape parameters, and initial slope indicators.

9. The apparatus of claim 8 wherein the initial slope indicators are defined by a ratio of an instantaneous crack opening displacement and a final crack displacement.

10. The apparatus of claim 8 wherein the cohesive strength corresponds to maximum tractions in a normal direction and a shear direction.

11. A method of measuring interfacial debonding of an adhesive interface, the method comprising:
forming a deformation of a coating, wherein:
the coating is bonded to a substrate comprising an opening;
the coating covers the opening; and
the deformation is formed by increasing a pressure of a fluid in contact with the coating;
acquiring imaging data of the deformation while forming the deformation;
acquiring pressure data of the fluid while forming the deformation of the coating; and
performing an analysis of an interfacial debonding of the coating from the substrate, wherein the analysis utilizes the imaging data and the pressure data.

12. The method of claim 11 wherein the analysis of the interfacial debonding of the coating from the substrate utilizes full triaxial displacement evolution of the deformation of the coating correlated with a history of the pressure of the fluid.

13. The method of claim 11 wherein the analysis of the interfacial debonding of the coating from the substrate utilizes Digital Image Correlation (DIC) and inverse Finite Element Method (FEM) simulations using Cohesive Zone Modeling (CZM).

14. The method of claim 13 wherein the CZM uses zero-thickness elements.

15. The method of claim 13 wherein the CZM follows a Park-Paulino-Roesler (PPR) formulation.

16. The method of claim 23 wherein the CZM utilizes a plurality of parameters of the deformation including four fracture parameters in a normal and a tangential direction.

17. The method of claim 16 wherein the plurality of parameters comprise adhesion fracture energies, cohesive strength, shape parameters, and initial slope indicators.

18. The method of claim 17 wherein the initial slope indicators are defined by a ratio of an instantaneous crack opening displacement and a final crack displacement.

19. The method of claim 17 wherein the cohesive strength corresponds to maximum tractions in a normal direction and a shear direction.

20. The method of claim 11 wherein:
the substrate and the coating are coupled to a fixture comprising first opening and a channel;
the opening in the substrate is a second opening;
the second opening is covered by the coating;
the fluid in contact with the coating extends from the coating, through the channel, and to a pump; and
increasing the pressure of the fluid in contact with the coating is performed by activating the pump.
